(19) United States
(12) Patent Application Publication
(10) Pub. No.: US 2003/0105641 A1
(43) Pub. Date: Jun. 5, 2003

(54) Electronic ticketing and validation system and method

(75) Inventor: Woodson C. Lewis, St. Louis, MO (US)

Correspondence Address: POLSTER, LIEDER, WOODRUFF & LUCCHESI, 763 SOUTH NEW BALLAS ROAD, ST. LOUIS, MO, 63141-8750, US

(73) Assignee: Woodson Lewis

(21) Appl. No.: 09/527,927

(22) Filed: Mar. 17, 2000

(51) Int. Cl. G06F 17/60; G06K 5/00

(52) U.S. Cl. 705/1; 235/380

(57) ABSTRACT

An electronic ticketing and validation system is comprised of a computer capable of accessing the Internet, a computer system capable of being accessed by the computer over the Internet, the computer system for providing a screen to the computer once the computer accesses the computer system with such screen including information relating to the selection of an event, purchasing of a ticket for the event, payment for the ticket, and generating the ticket to be used to gain entrance at the event, and a validation system for validating the ticket to allow entrance into the event. The system is also capable of issuing the ticket in electronic form, in paper form, as a smart card, or as a season pass.

### BACKGROUND OF THE INVENTION

This invention relates to a system and a method for providing an electronic ticket and validation of the electronic ticket for various events and more particularly to a system and a method for selecting and purchasing a ticket over the Internet and validating the ticket at the site of the event.

The entertainment industry sector continues to expand at an unprecedented rate as individual's discretionary income increases and as the entertainment industry expands, diversifies, and appeals to a broader portion of the population. Outside of restaurants, more individuals spend discretionary income on entertainment than practically any other industry. However, gaining admission to entertainment events is becoming more challenging every day. Long lines form in advance of events as patrons scurry to obtain admission tickets. In many cases, an early arrival is required in order to secure an admission ticket to avoid the possibility of a sold out event. In an attempt to avoid these problems, many entertainment venues have started to allow consumers the opportunity to order advance tickets by telephone. However, unless the tickets are mailed to the customer, the customer is still required to visit the venue prior to the event in order to obtain the ticket. In most cases, the patron is then required to prove their identity and/or present the credit or debit card which was used to purchase their ticket over the phone. Again, even employing this purchase method, a line is not avoided and the customer is still inconvenienced.

Additionally, as competition between different entertainment sectors for the same consumer discretionary dollar increase, consumer convenience becomes an important factor as to which venue the consumer will choose. Long lines, lengthy transaction times, and sold out events play a part in the consumer's decision making process. In view of such factors, there thus remains a need for an electronic ticketing and validation system which is reduces or eliminates the need to stand in line to either obtain tickets or to validate the tickets.

The present invention is designed to obviate and overcome many of the disadvantages and shortcomings associated with the currently available methods for purchasing a ticket for an event. Particularly, the present invention is designed to provide a user of the Internet with the ability to purchase a ticket, to download the ticket for printing, and then to provide a capability for quickly validating the ticket validated at the event or activity.

### SUMMARY OF THE INVENTION

The present invention is an electronic ticketing and validation system which comprises a computer capable of accessing the Internet, a computer system capable of being accessed by the computer over the Internet, the computer system for providing a screen to the computer once the computer accesses the computer system with such screen including information relating to the selection of an event, purchasing of a ticket for the event, payment for the ticket, and generating the ticket to be used to gain entrance at the event, and a validation system for validating the ticket to allow entrance into the event.

In another form, the present invention is an electronic ticketing and validation system which comprises a computer capable of accessing the Internet, a computer system capable of being accessed by the computer over the Internet, the computer system for providing a screen to the computer once the computer accesses the computer system with such screen including information relating to the selection of a season pass for an event, purchasing of the season pass, payment for the season pass, and generating the season pass to be used to gain entrance to the event, and a validation system for validating the season pass to allow entrance into the event.

In still another form, the present invention is a method for selecting a ticket for an event and validating the ticket at the event which comprises the steps of browsing a website of an event provider over the Internet, viewing information relating to an event, selecting the event to purchase a ticket, paying for the ticket, receiving the ticket, and validating the ticket at the event to allow entrance into the event.

In light of the foregoing comments, it will be recognized that a principal object of the present invention is to provide an electronic ticketing and validation system for selecting, purchasing, and validating a ticket for an event.

A further object of the present invention is to provide an electronic ticketing and validation system for selecting, purchasing, and validating a ticket which is of simple design and which can be easily employed with highly reliable results.

A further object of the present invention is to provide an electronic ticketing and validation system which allows a consumer to obtain one or more tickets to an event without ever having to stand in a line. Using the system of the present invention allows a consumer to select a venue, select an event at the venue, select a seating preference, and select a method of payment for the purchase of a ticket. The tickets may be purchased on a 24 hours basis every day of the week or year without being limited to a box office's hours of operation. Further, the consumer is able to bypass all lines in order to gain admission into an event. The electronic ticketing and validation system also allows a consumer to print out tickets at the consumer's personal computer which eliminates the need or requirement for the consumer to pick up tickets at some other location such as a box office. The system of the present invention also allows consumers to gain access to and to display their purchased tickets on Internet enabled or connected handheld devices, such as personal communications system cellular phones or pages or personal organizer type devices such as a portable digital assistant devices, for subsequent validation at the event to permit entry. The system of the present invention permits out of town customers to be able to select, purchase, and receive tickets prior to their trip to the town or city. Additionally, the present system allows a customer to purchase a ticket as a gift and to send or forward the ticket as a present. If a ticket is purchased as a gift it is also possible to print on the ticket a message from the giving party.

The present invention is advantageous for a venue because the system reduces overhead costs such as reduced staff, facilities, and equipment costs inherent with front windows or box office operations. There will also be less need for a “will call” window where customers may go to pick up tickets being held at the venue. There is further reduction in costs associated in printing tickets and mailing tickets. The venue will also reduce the need for expensive in-house ticket dispensing machines.

These and other objects and advantages of the present invention will become apparent after considering the following detailed specification in conjunction with the accompanying drawings, wherein:

### BRIEF DESCRIPTION OF THE DRAWINGS

FIG. 1 is a block diagram of an electronic ticketing and validation system constructed according to the present invention;

FIG. 2 is a front view of a ticket of the present invention;

FIG. 3 is a front view of an identification card of the present invention;

FIG. 4 is a back view of the identification card shown in FIG. 3;

FIG. 5 is a block diagram of another embodiment of an electronic ticketing and validation system constructed according to the present invention;

FIG. 6 is a block diagram of another preferred embodiment of an electronic ticketing and validation system constructed according to the present invention; and

FIG. 7 is a block diagram of still another preferred embodiment of an electronic ticketing and validation system constructed according to the present invention.

### DETAILED DESCRIPTION OF THE PREFERRED EMBODIMENTS

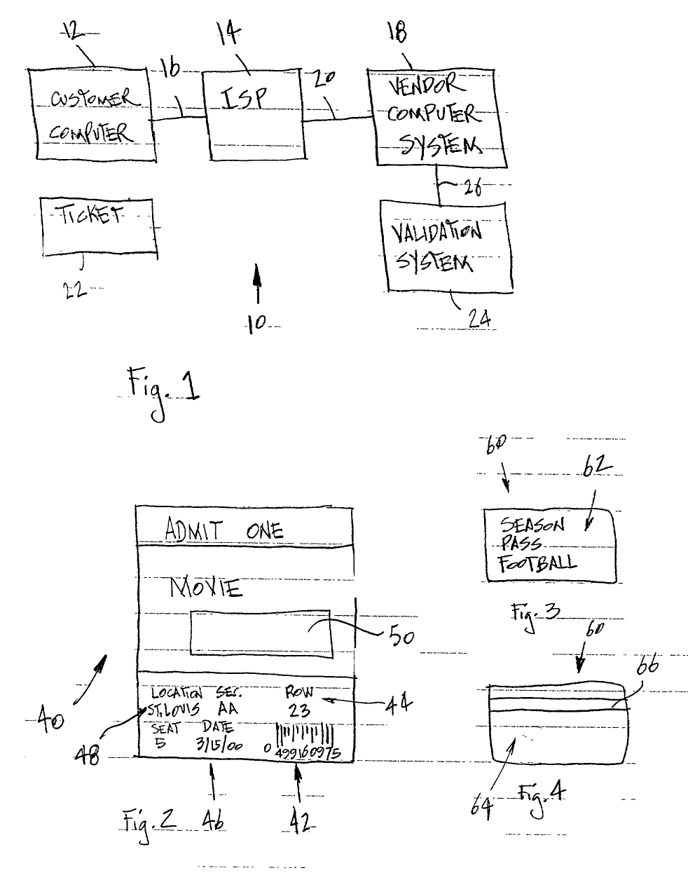

Referring now to the drawings, wherein like numbers refer to like items, number 10 identifies a preferred embodiment of a system for selecting, purchasing, and validating a ticket constructed according to the present invention. The system 10 is shown in FIG. 1 to comprise a remote computer or a customer computer 12 which is capable of being connected to the Internet. For example, the customer computer 12 may be connected to an Internet Service Provider (ISP) system 14 via a connection 16, such as a telephone line. The ISP system 14 is further capable of connecting or finding a website being hosted by a vendor computer system 18. The ISP system 14 is connected to the vendor computer system 18 by a connection 20, such as a telephone line connection. Other examples of the connections 16 or 20 are cable, ISDN, TI, or other type of broadband connection. The customer computer 12 is allowed access to the vendor computer system 18 through the ISP system 14 by use of a commonly available web browser or similar software package. The vendor computer system 18 is capable of hosting a website which presents various pages to the customer computer 12, as is well known. A customer operating the customer computer 12 is able to interact with the website being hosted by the vendor computer system 18. In particular, a customer may be presented with various screens with such screens presenting information concerning events, seating available for such events, and ticket prices for each event.

Once a customer makes a selection and pays for the selection, a ticket 22 is sent to the customer by various methods. The ticket 22 may be of different forms or formats. By way of example only, the ticket 22 may be printed out on a printer (not shown) connected to the customer computer 12, the ticket 22 may be mailed to the customer in the form of a paper ticket or as part of a plastic card or a smart card, or the ticket 22 may be in electronic form for use on a PDA type device such as a Palm Pilot type device or a cell phone as will be discussed herein. The ticket 22, if in printed form, may have printed thereon information such as a bar code, event date and time, seat number, and advertisement.

The ticket 22 is used to gain entrance into an event or activity. A validation system 24 which is connected to or associated with the vendor computer system 18 is placed at the location or site of the event. The ticket 22 is used at the validation system 24 in order to enter the event. The validation system 24 is also in communication with the vendor computer system 18 via a connection 26. The connection 26 may take different forms which include an electrical wire or wires, a telephone line, an infrared device, or any other connection in which information or data may be transferred between the validation system 24 and the vendor computer system 18. It is also contemplated that the validation system 24 may be incorporated within or be a part of the vendor computer system 18. Information read or entered from the ticket 22 is transmitted from the validation system 24 to the vendor computer system 18. The vendor computer system 18 verifies that the ticket 22 is valid for the event and sends a signal over the connection 26 to the validation system 24 which permits the customer to enter. It is also possible that the validation system 24 may make the determination of whether the ticket 22 is valid without verification from the vendor computer system 18.

The pages or screens presented at the customer computer 12 may include advertising banners or advertisements. Further, the ticket 22 may also have one or more of the advertisements printer thereon. The system 10 may also support a reward or frequent user program or a coupon program. For example, the screens or the ticket 22 may have printed thereon the progress of the customer within a program or even discounts for future ticket purchases. The system 10 is also capable of sending messages, such as e-mails, to the customer computer 12 about upcoming events, reviews, or other information.

FIG. 2 shows a front view of a ticket 40, similar to the ticket 22, which is generated by the system 10. The ticket 40 may be printed out on a printer (not shown) associated with or part of the customer computer 12. The ticket 40 has an area 42 in which a code, such as an universal product code (UPC) or a unique identifier code, is printed. Although an UPC has been described other codes, such as alphanumeric type codes, are possible and contemplated for use by the system 10. Additional information may be printed on the ticket 40 such as seating information 44, date of the event 46, location of the event 48, and an area 50 for the placement of an advertisement. Other formats and layouts of the ticket 40 are possible with the important feature of the ticket 40 being the use of an area 42 having placed therein the UPC or other code. As has been discussed, the UPC is used by the validation system 24 to verify the ticket 40 and to allow the customer entrance into the event. For example, the UPC code for the particular ticket 40 may be stored in the computer system 18 and once the ticket 40 is used in conjunction with the validation system 24 the UPC code is read into the computer system 18. If the UPC code matches, then the ticket 40 is verified and the holder of the ticket 40 is allowed entrance into the event.

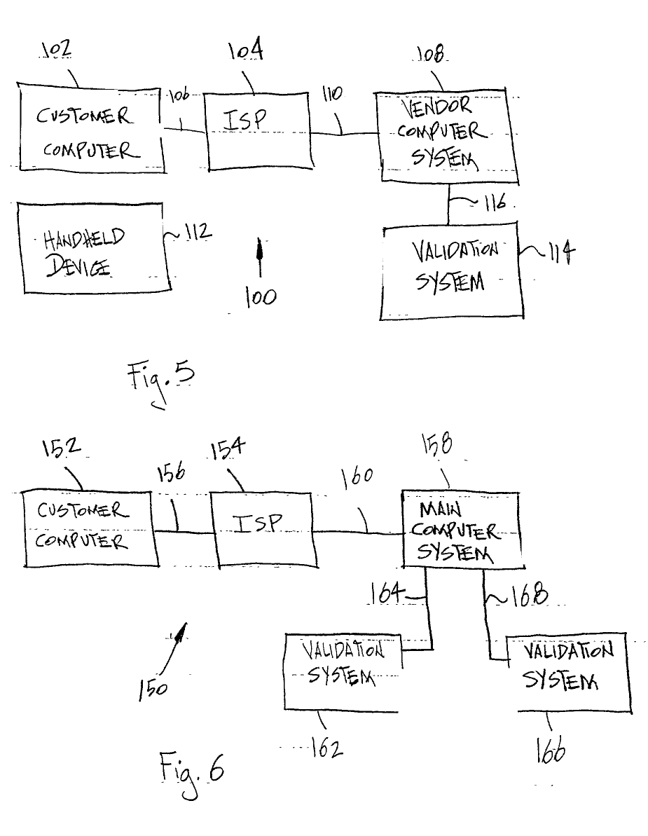

Referring now to FIGS. 3 and 4, a plastic identification card 60, such as a credit card, is shown. The card 60 may be used in place of the ticket 22 or 40 for such events which would require a season pass or ticket. For example, a baseball season pass, a football season pass, a series of theater shows, or a pass to an amusement park are examples of events in which it would be convenient to have a season pass. The card 60 has a front side 62 on which may be printed information relating to seating information, schedule of events, team logo, or even an advertisement. The card 60 also has a back side 64 which has a magnetic strip 66. The magnetic strip 66 is used to encode information. The card 60 is used with the validation system 24 by inserting the card 60 into a magnetic card reader (not shown) associated with the validation system 24. The card reader is capable of reading the information encoded on the magnetic strip 66 and sending this information to the vendor computer system 18 for verification and validation. Further, use of the card 60 may require a personal identification number (PIN) be entered at the validation system 24 to provide additionally security in case the card 60 has been lost or stolen. The PIN would be assigned at the time the customer receives the card 60. Once validated, the card 60 may be removed from the card reader and the customer is allowed to enter into the event. Although the card 60 has been shown to be a plastic type identification card it is also possible and contemplated to use other cards, such as a paper card having a magnetic strip. The card 60 may also be a smart card which has embedded within the card a chip which has recorded therein information related to the validation code or UPC, seat location, and event. In the case of the use of a smart card for the season ticket pass, the card reader will be of the type capable of reading the information encoded on the smart card for verification and validation. Further, the card 60 may take on other forms or formats such as a CD-ROM, DVD, or a cassette tape.

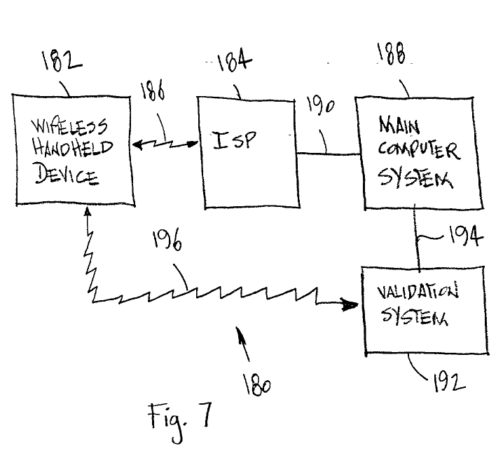

With reference now to FIG. 5, another preferred embodiment of an electronic ticketing and validation system 100 is shown. The system 100 comprises a remote computer or a customer computer 102 which is capable of being connected to the Internet. For example, the customer computer 102 may be connected to an ISP system 104 by a connection 106, such as a telephone line. The ISP system 104 is further capable of connecting or finding a website being hosted by a vendor computer system 108. The ISP system 104 is connected to the vendor computer system 108 by a connection 110, such as a telephone line connection. Other examples of the connections 106 or 110 are cable, ISDN, T1, or other type of broadband connection. The customer computer 102 is allowed access to the vendor computer system 108 through the ISP system 104 by use of a commonly available web browser or similar software package. The vendor computer system 108 is capable of hosting a website which presents various pages to the customer computer 102. A customer operating the customer computer 102 is able to interact with the website being hosted by the vendor computer system 108 to review events, select an event, purchase tickets, receive tickets, and pay for tickets. In particular, a customer may be presented with various screens with such screens presenting information concerning events, seating available for such events, payment methods, and ticket prices for each event.

With respect to the system 100, once an event is selected and a ticket is purchased, a ticket, in the form of a code, is sent from the vendor computer system 108 to the customer computer 102 to be downloaded into a handheld device 112. The ticket may be downloaded into the device 112 in any known manner, such as infrared transmission, connecting a port on the device 112 to a port on the computer 102, or even by use of a disk. The handheld device 112 may be a PDA (personal data assistant) device such as a Palm Pilot type device, an MP3 type device, a cell phone, a pager, or a personal communications system device such as an internet enabled cellular phone or page. Once the ticket in electronic form is downloaded into the handheld device 112, the customer takes the handheld device 112 to the event and the ticket is entered, downloaded, or interfaced with a validation system 114. The validation system 114 is associated with or connected to the vendor computer system 108 via a connection 116. The connection 116 may take different forms which include an electrical wire or wires, a telephone line, an infrared device, or any other connection in which information or data may be transferred between the validation system 114 and the vendor computer system 108. It is also contemplated that the validation system 114 may be incorporated within or be a part of the vendor computer system 108. Information read or entered from the handheld device 112 is transmitted from the validation system 114 to the vendor computer system 108. The vendor computer system 108 verifies that the code or the ticket is valid for the event and sends a signal over the connection 116 to the validation system 114 which permits the customer to enter. It is also possible that the validation system 114 may make the determination of whether the entered code is valid without verification from the vendor computer system 108. Some examples of how the handheld device 112 may transmit the code, which in essence is the ticket in electronic form, is by infrared signal, audio signal such as DTMF (dual tone multi frequency), presenting an UPC code on a screen associated with the device 112 and then having a wand (not shown) associated with or a part of the validation system 114 enter the UPC code into the system 114, having a port, such as RS-232 or other similar port, being available on the device 112 and the system 114 for transmission of the code.

Another preferred embodiment of an electronic ticketing and validation system 150 is illustrated in FIG. 6. The system 150 comprises a customer computer 152 which is capable of being connected to the Internet by use of an ISP system 154. The customer computer 152 is connected to the ISP system 154 by a telephone connection 156. The ISP system 154 is further capable of connecting or finding a website being hosted by a main computer system 158. As described above, the ISP system 154 is connected to the main computer system 158 via a connection 160. The customer computer 152 is allowed access to the main computer system 158 through the ISP system 154 by use of a commonly available web browser or similar software package. The main computer system 158 is capable of hosting numerous websites which presents virtual venues or various pages to the customer computer 152. A customer operating the customer computer 152 is able to interact with the various websites being hosted by the main computer system 158 to review various events, select an event, purchase tickets, receive tickets, and pay for tickets. A customer may conduct a search of the various websites to determine if a particular event is or will be available. Such search may result in the customer being presented with various screens with such screens presenting information concerning events, seating available for such events, payment methods, and ticket prices for each event. Once an event is selected by the customer a ticket or a pass, such as the ticket 22 or 40 or the pass 60, may be sent to the customer computer 152 or to the customer.

Also associated with the main computer system 158 is a validation system 162. The validation system 162 is connected to the main computer system 158 by an electrical connection 164. The validation system 162 may be positioned or located at the venue or the event site. The main computer system 158 may also be located at the venue or the event site or it may be located at a remote location. The main computer system 158 may further have another validation system 166 connected to it by another electrical connection 168. The validation system 166 may be at the same venue or event site as the validation system 162 or the validation system 166 may be located at another venue. The validation systems 162 and 166 are used to read either the tickets 22 or 40, the card 60, or even information from the hand held device 112, in order to allow a customer into an event.

FIG. 7 shows another preferred embodiment of an electronic ticketing and validation system 180. The system 180 comprises a wireless handheld device 182 such as an PDA type device, a personal communications system device which includes a cellular telephone or is enabled to access the Internet, or a pager which is capable of accessing the Internet. The device 182 is an example of a personal computer which is small and compact in design and includes the function of being able to send and receive telephone messages. The device 182 is capable of being connected to the Internet by use of an ISP system 184 through the use of wireless or cellular service 186. The ISP system 184 is further capable of connecting or finding a website being hosted by a main computer system 188. The ISP system 184 may be connected to the main computer system 188 by a conventional land line connection 190 or the connection 190 may even be wireless. The device 182 is allowed access to the main computer system 188 through the ISP system 184 by use of a commonly available web browser or similar software package. The main computer system 188 is capable of hosting numerous websites which presents virtual venues or various pages to the device 182. A customer operating the device 182 is able to interact with the various websites being hosted by the main computer system 188 to review various events, select an event, purchase tickets, receive tickets, and pay for tickets. A customer may conduct a search of the various websites to determine if a particular event is or will be available. Once an event is selected by the customer a ticket or a pass may be sent to the device 182 or to the customer. The ticket may be in the form of an electronic ticket or the device 182 may have printing capabilities to print out a paper ticket.

The main computer system 188 also has a validation system 192 connected to the main computer system 188 by an electrical connection 194. The validation system 192 may be positioned or located at the venue or the event site. The main computer system 188 may also be located at the venue or the event site or it may be located at a remote location. The validation system 192 is used to read either a paper ticket or information from the handheld device 182, in order to allow a customer into an event. For example, the handheld device 182 may send a signal, such as an audio signal 196, to the validation system 192. The validation system 192 would then authenticate or validate the signal 196 to determine if the customer should be allowed entrance into the event. The validation system 192 may either determine if the signal 196 is valid or the validation system 192 may send the signal 196 to the main computer system 188 for the system 188 to check the validity of the signal 196. Once the signal 196, in essence the ticket, is validated the customer is allowed into the event. The signal 196 may take on other forms than an audio signal such as an infrared signal or an UPC displayed on a display associated with the device 182.

The electronic ticketing and validation systems 10, 100, 150, and 180 may be used to supplement or replace current ticketing methods or processes. The systems 10, 100, 150, and 180 also are used to enhance consumer convenience, promote ticket sales, and reduce the overhead of a venue.

From all that has been said, it will be clear that there has thus been shown and described herein an electronic ticketing and validation system and method which fulfills the various objects and advantages sought therefor. It will be apparent to those skilled in the art, however, that many changes, modifications, variations, and other uses and applications of the subject electronic ticketing and validation system and method are possible and contemplated. All changes, modifications, variations, and other uses and applications which do not depart from the spirit and scope of the invention are deemed to be covered by the invention, which is limited only by the claims which follow.

What is claimed is:

1. An electronic ticketing and validation system comprising:
a computer capable of accessing the Internet;
a computer system capable of being accessed by the computer over the Internet, the computer system for providing a screen to the computer once the computer accesses the computer system with such screen including information relating to the selection of an event, purchasing of a ticket for the event, payment for the ticket, and generating the ticket to be used to gain entrance at the event; and
a validation system for validating the ticket to allow entrance into the event.

2. The system of claim 1 wherein the computer is a handheld device.

3. The system of claim 1 wherein the ticket has a unique identifier code and the validation system is capable of reading the code and verifying the code to allow entrance into the event.

4. The system of claim 3 wherein the unique identifier code is a universal product code.

5. The system of claim 1 wherein the computer system is capable of sending the generated ticket to the computer for the computer to print out the ticket.

6. The system of claim 5 wherein the printed ticket has a code printed thereon and the validation system is capable of reading the printed code.

7. The system of claim 1 wherein the ticket is generated as a paper ticket having a magnetic strip thereon with the magnetic strip having a code encoded therein.

8. The system of claim 7 wherein the validation system further comprises a magnetic card reader for reading the code in the magnetic strip.

9. An electronic ticketing and validation system comprising:
a computer capable of accessing the Internet;
a computer system capable of being accessed by the computer over the Internet, the computer system for providing a screen to the computer once the computer accesses the computer system with such screen including information relating to the selection of a season pass for an event, purchasing of the season pass, payment for the season pass, and generating the season pass to be used to gain entrance to the event; and
a validation system for validating the season pass to allow entrance into the event.

10. The system of claim 9 wherein the season pass has a unique identification code associated therewith, the code being read by the validation system to verify that the season pass is valid in order to allow entrance into the event.

11. The system of claim 10 wherein the validation system is connected to the computer system and the code is sent from the validation system to the computer system.

12. The system of claim 9 wherein the season pass is a card having a magnetic strip thereon with the magnetic strip having a code encoded therein.

13. The system of claim 12 wherein the validation system comprises a magnetic card reader for reading the code encoded in the magnetic strip of the card.

14. The system of claim 9 wherein the season pass comprises a smart card having a code stored therein.

15. The system of claim 14 wherein the validation system comprises a smart card reader for reading the code stored in the smart card.

16. The system of claim 9 further comprising a second validation system for validating the season pass to allow entrance into the event.

17. The system of claim 9 wherein the season pass has event information printed thereon.

18. A method for selecting a ticket for an event and validating the ticket at the event comprising the steps of:
browsing a website of an event provider over the Internet;
viewing information relating to an event;
selecting the event to purchase a ticket;
paying for the ticket;
receiving the ticket; and
validating the ticket at the event to allow entrance into the event.

19. The method of claim 18 wherein the viewing information step comprises determining a seat selection.

20. The method of claim 18 wherein the selecting step comprises selecting a season pass to the event.
